(19) United States
(12) Patent Application Publication
(10) Pub. No.: US 2019/0230981 A1
(43) Pub. Date: Aug. 1, 2019

(54) COLLAPSIBLE WATER PIPE

(71) Applicant: LDM Hospitality LLC, Denver, CO (US)

(72) Inventor: Emanuel Isler, Denver, CO (US)

(21) Appl. No.: 16/378,713

(22) Filed: Apr. 9, 2019

Related U.S. Application Data
(63) Continuation-in-part of application No. 15/665,000, filed on Jul. 31, 2017, now abandoned.
(60) Provisional application No. 62/373,447, filed on Aug. 11, 2016.

(51) Int. Cl. A24F 1/30; A24F 7/02; A24F 5/00; F16L 27/12

(52) U.S. Cl. CPC A24F 1/30; F16L 27/12; A24F 5/00; A24F 7/02

(57) ABSTRACT

A collapsible water pipe is disclosed. An example collapsible water pipe includes a body and a base forming a water basin, the base connected to the body. A percolation plate is provided on the base inside the body. In an example, the percolation plate is porous and/or shaped as a mountain to increase efficiency. An extension is removably connected to a top of the body. A stem is removably connected to a side of the base. The water pipe is collapsible for transport and/or providing in a storage configuration. The extension is connected to the body, and the stem is connected to the base for assembly in an operating configuration.

### CROSS REFERENCE TO RELATED APPLICATIONS

This application is a continuation-in-part (CIP) patent application of U.S. patent application Ser. No. 15/665,000 filed Jul. 31, 2017 titled “Collapsible Water Pipe” of Emanuel Isler, which claims the priority benefit of U.S. Provisional Patent Application No. 62/373,447 filed Aug. 11, 2016 titled “Collapsible Water Pipe” of Emanuel Isler, each hereby incorporated by reference for all that it discloses as though fully set forth herein

### BACKGROUND

A water pipe (also referred to as a hookah) is device for vaporizing and smoking flavored tobacco or other smoking material. The vapor and/or smoke passes through a water basin before inhalation. Although water pipes may be made of any desired material, at least the water (or other liquid) basin is typically made of glass or ceramic.

The water pipe is believed to have originated in Persia, and spread to the east into India and Egypt. More recently, the water pipe has gained in popularity in western cultures (e.g., North America, South America, Europe, and Australia), Asia, and Africa.

### BRIEF DESCRIPTION OF THE DRAWINGS

FIG. 1 is a perspective view of an example collapsible water pipe in an operating configuration.

FIG. 2 is a perspective view of an example collapsible water pipe in a storage and/or transport configuration.

FIG. 3 is a side view of the example collapsible water pipe.

FIG. 4 is a top view of the example collapsible water pipe.

FIGS. 5A-B are component views of a base plate of the example collapsible water pipe.

FIG. 6 is a component view of a stem of the example collapsible water pipe.

FIG. 7 is a component view of an extension of the example collapsible water pipe.

FIG. 8 is a component view of a body of the example collapsible water pipe.

FIG. 9 shows another example collapsible water pipe.

FIG. 10 shows the base of the example collapsible water pipe of FIG. 9.

FIG. 11 shows the body of the example collapsible water pipe of FIG. 9.

FIG. 12 shows the neck of the example collapsible water pipe of FIG. 9,

FIG. 13 shows the percolation plate of the example collapsible water pipe of FIG. 9.

FIG. 14 shows the stem of the example collapsible water pipe of FIG. 9.

### DETAILED DESCRIPTION

A collapsible water pipe is disclosed. In an example, the water pipe can be used as a water pipe in an extended configuration, and collapsed when not in use, thereby making it readily portable.

The example collapsible water pipe may be approximately the size and shape of a soda can, and indeed, can even be made to appear as a soda can or chips container, thus making it disguisable.

The example collapsible water pipe may be collapsed and the stem and locking extension removed (e.g., threaded off) for storage and/or transport. A locking lid (not shown) may also be provided for storage and/or transport. The example collapsible water pipe may be extended and the stem and locking stem replaced (e.g., threaded on) for use, In an example, the collapsible water pipe has a locking extension (e.g., with thumb holes), and a fritted base plate to increase efficiency.

An example of the collapsible water pipe includes a mountain shaped percolator. In an example, the “mountain percolator” may be provided over the fritted base and operates in tandem with the fritted base. The “mountain percolator” may include additional holes and slots to further maximize percolation and smoke creation. In another example, the “mountain percolator” may replace the disc-shaped base,

The example collapsible water pipe may also include O-Rings. The stem-piece opening and/or the base-plate may have O-rings to compliment the engineered threads to ensure pressurization and prevent the leakage of liquid (e.g., water). The O-rings may be seated in specifically designed ridges.

The example collapsible water pipe may also include a collapsible Tube component with a rounded mouthpiece provided together as one piece.

The example collapsible water pipe may also include threads to ensure ease of locking and unlocking components with one another.

Before continuing, it is noted that as used herein, the terms “includes” and “including” mean, but is not limited to meaning, “includes” or “including” and “includes at least” or “including at least.” The term “based on” means, but is not limited to meaning, “based on” and “based at least in part on.”

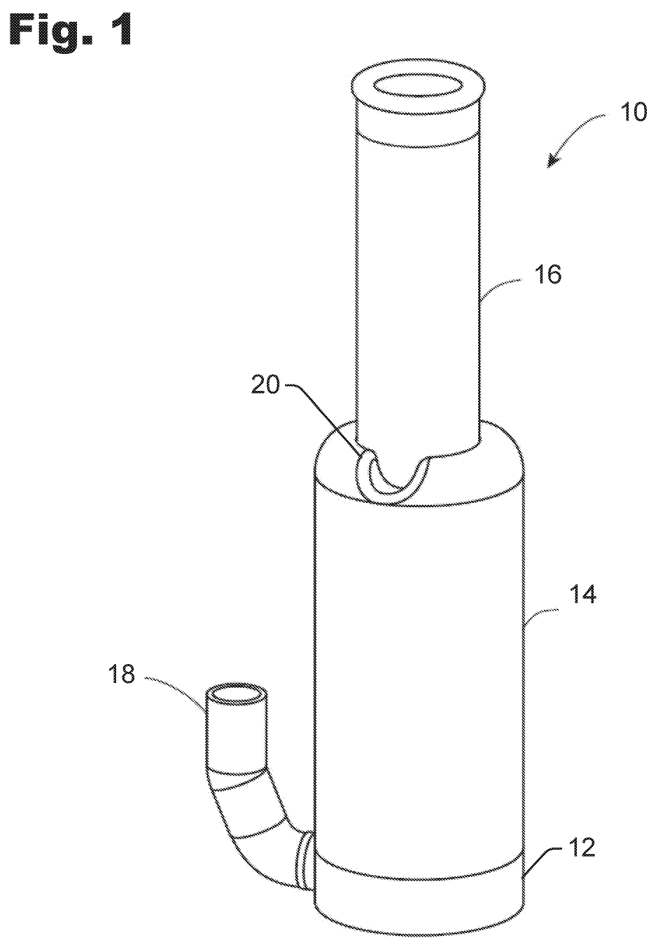

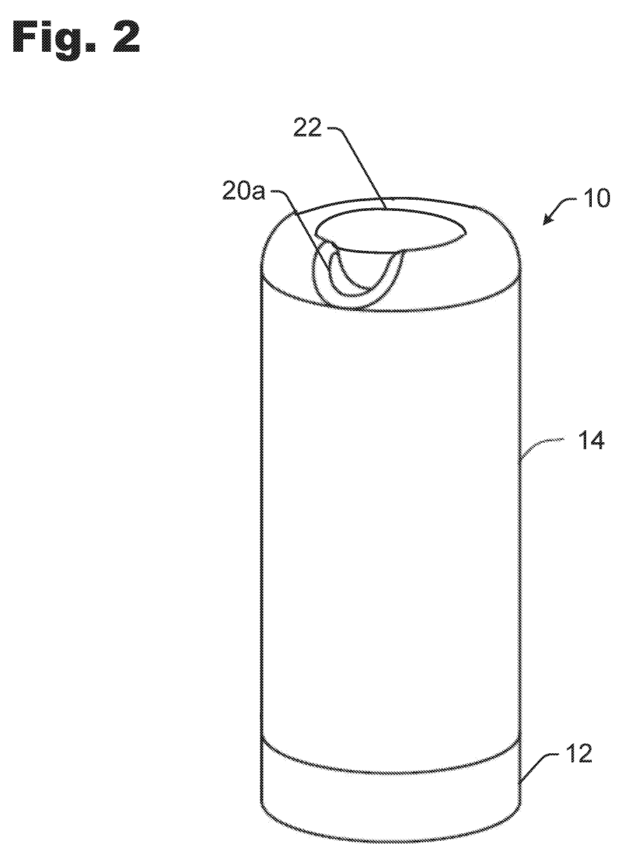

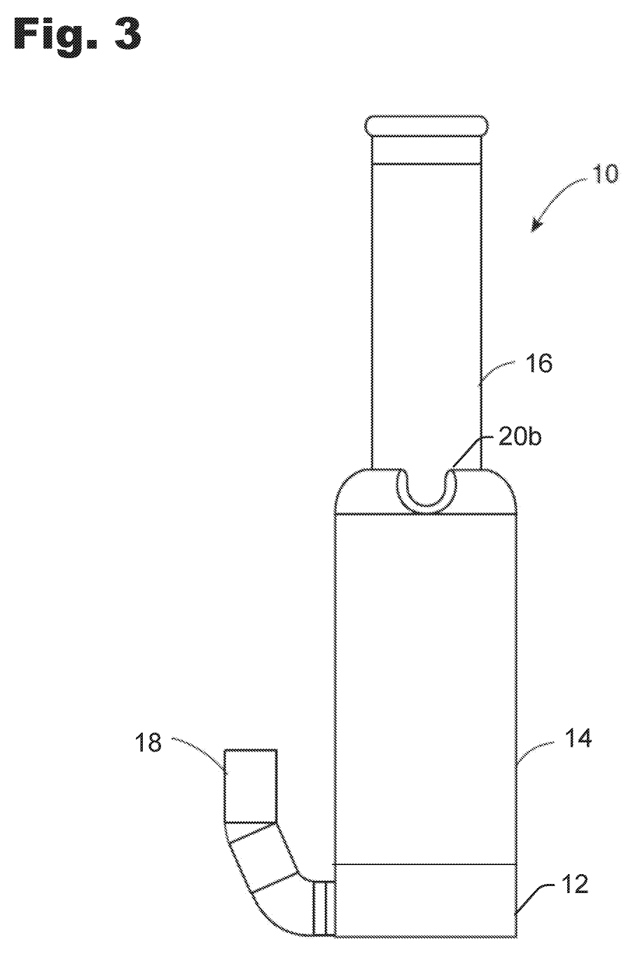

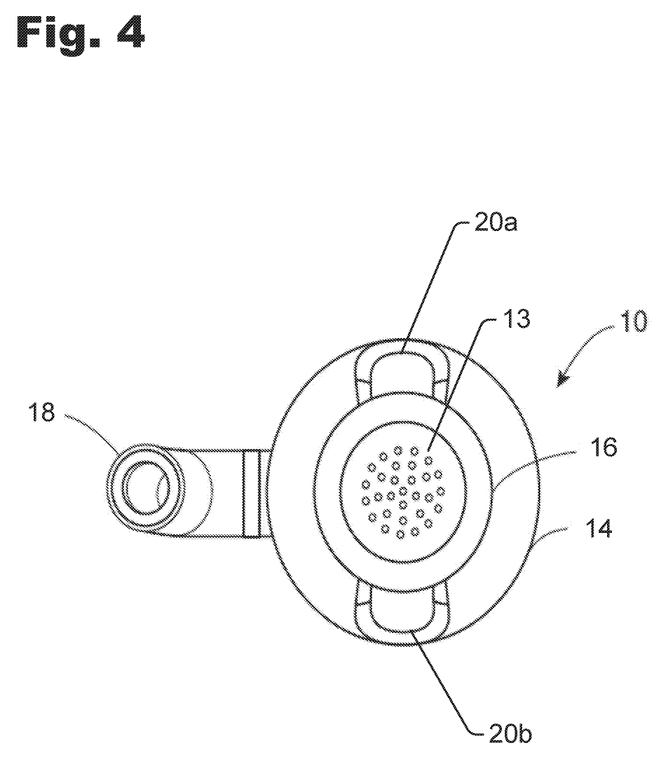

FIG. 1 is a perspective view of an example collapsible water pipe 10 in an operating configuration. FIG. 2 is a perspective view of an example collapsible water pipe 10 in a storage and/or transport configuration. FIG. 3 is a side view of the example collapsible water pipe 10 as it is shown in FIG. 1. FIG. 4 is a top view of the example collapsible water pipe as it is shown in FIG. 1.

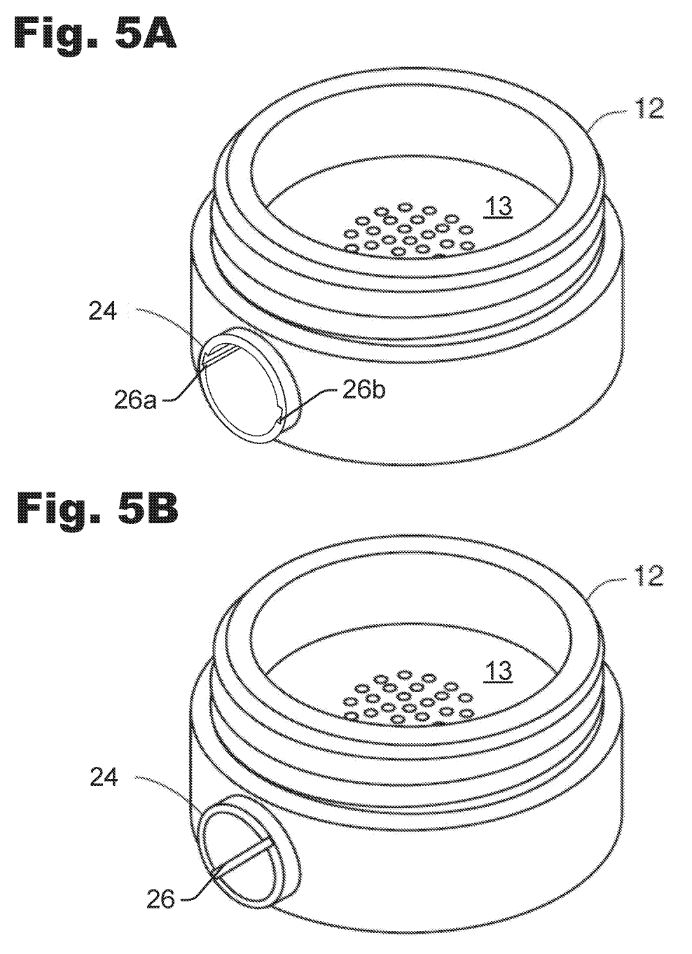

An example collapsible water pipe 10 includes a base plate 12 forming a water basin, and a body 14. The base plate 12 may have a perforated floor 13, as can be seen, e.g., in FIGS. 4 and 5A-B. The body 14 can be connected to, and disconnected from, the base plate 12. An extension 16 is connectable to the body 14. In an example, the extension 16 interlocks with the body 14. A mouthpiece or stem 18 is connectable to the base plate 12.

In an example, the body 14 has one or more formations 20a-b for a user's thumb and/or other fingers. Also in an example, a lid or cap 22 may be provided to cover the opening in the top of the body 14 when the extension 16 is removed. The cap 22 may be interlocking, threaded into the opening, or otherwise connectable.

In an example, the base plate 12 may be fritted to increase efficiency. The body 14 and/or other components of the water pipe 10 may be injection-molded from high quality polycarbonate to ensure glass-like qualities with superior durability and heat resistance. Of course, other materials may also be implemented as will be readily appreciated by those having ordinary skill in the art after becoming familiar with the teachings herein.

The water pipe 10 is shown assembled in an operating configuration in FIG. 1. To assemble the water pipe 10, the extension 16 and the stem 18 are removed from the body 14 (if stored therein), e.g., by disconnecting the body 14 from the base plate 12. The body 14 is reconnected to the base plate 12. The extension 16 is connected to the body 14, and the stem 18 is connected to the base plate 12 for assembly in the operating configuration.

The water pipe 10 is shown unassembled in a closed configuration for storage and/or transport in FIG. 2. To disassemble the water pipe 10 and configure it for storage and/or transport, the extension 16 is removed from the body 14 and the stem 18 is removed from the base plate 12. The body 14 is removed from the base plate 12 so that the extension 16 and the stem 18 can be placed inside the body 14. The body 14 can then be reconnected to the body 14. In this closed configuration, the water pipe 10 is ready for storage and/or transport.

In an example, the water pipe 10 in the closed configuration is approximately the size and shape of a soda can. The water pipe 10 may even be disguised (e.g., made to appear) as a soda can, potato chips or snack container, or other container. In an example, the water pipe 10 is readily portable, e.g., for packing in a suitcase, briefcase, purse, etc.

FIGS. 5A-B are component views of a base plate 12 of the example collapsible water pipe 10. In an example, the base plate 12 is generally cylindrical in shape, and has a perforated floor 13. The base plate 12 may also include a threaded portion where the body 16 can be threaded onto (and off of) the base plate 12. Other connections are also contemplated for connecting the body 14 to the base plate 12, as will be readily appreciated by those having ordinary skill in the art after becoming familiar with the teachings herein.

In another example, the base plate may include collapsible walls (not shown). For example, the walls may be interconnected cylindrical rings that are successively smaller (or larger) in diameter than the immediately adjacent one, so that the walls raise and lower telescopically. In this example, the walls may form the body 14 and a separate body may not be provided.

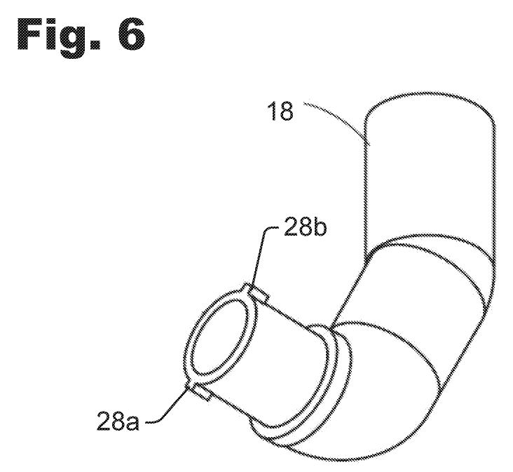

An opening 24 may be formed in the base plate 12 to connect the stem 18. FIG. 6 is a component view of a stem 18 of the example collapsible water pipe 10. The stem 18 may interconnect with the base plate 12 via a locking mechanism. For example, the opening 24 in the base plate 12 may include a slotted lock feature 26a-b configured to receive a tabbed lock feature 28a-b on the stem 18. The stem 18 is aligned with the opening 24 in a first orientation such that the tabs 28a-b engage with slots 26a-b and enable the stem 18 to be inserted into the opening 24. After insertion for a predetermined distance, the slots change direction by about 90 degrees so that the stem 18 can be rotated about 90 degrees to lock the stem 18 to the base plate 12 and secure the stem 18 to the base plate 12.

In an example, a plug 26 may be provided to cover the opening 24 in the base plate 12 when the stem 18 is removed from the base plate 12. The plus 26 may implement the same locking mechanism as the stem 18, or a separate connection (e.g., a push-pull rubber plug).

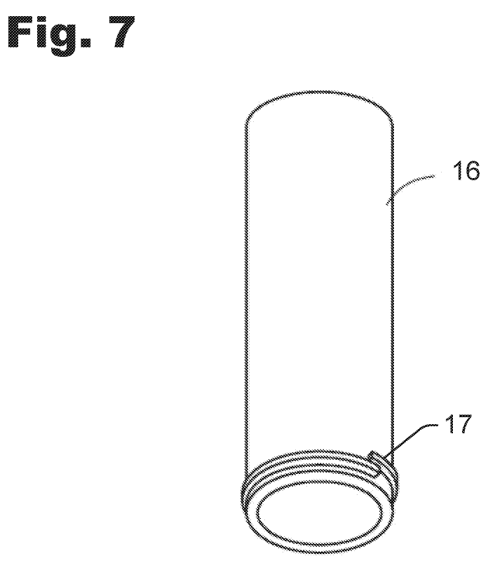

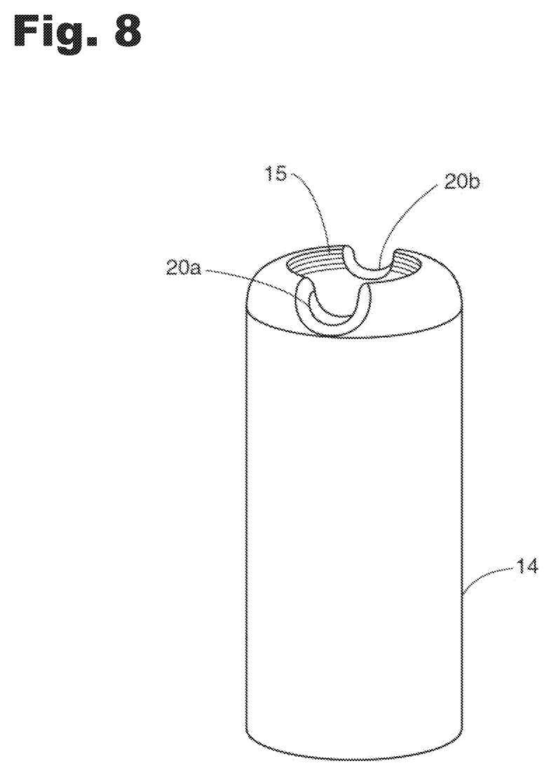

FIG. 7 is a component view of an extension 16 of the example collapsible water pipe 10. In an example, the extension 16 is connectable to the body 14. FIG. 8 is a component view of the body 14 of the example collapsible water pipe 10. For example, the extension 16 may have thread 17 that mates with thread 15 in the body 14. Other connections are also contemplated for connecting the extension 16 to the body 14, as will be readily appreciated by those having ordinary skill in the art after becoming familiar with the teachings herein.

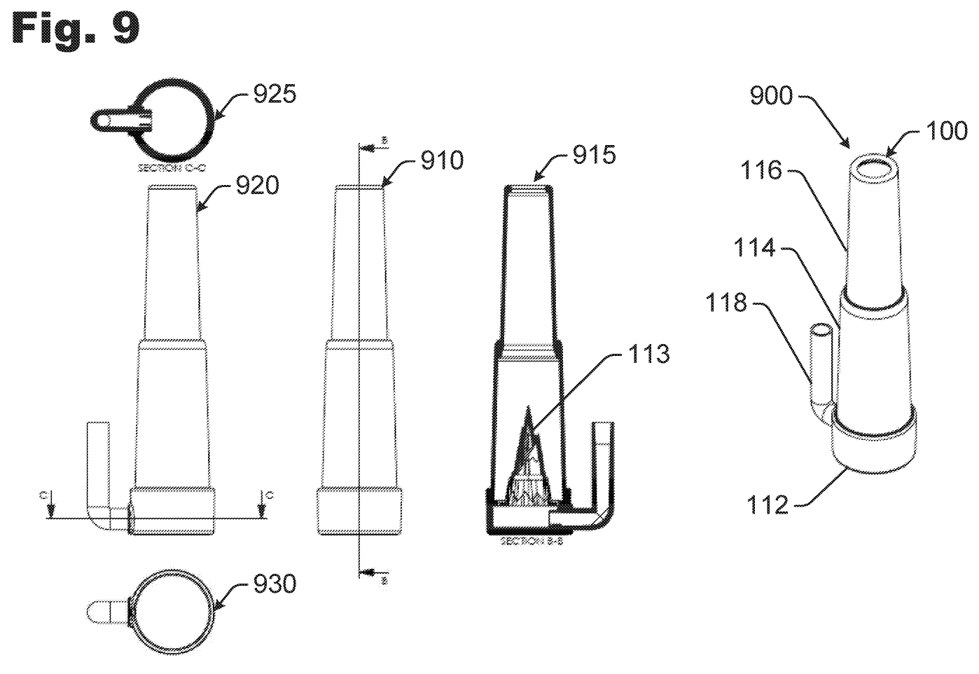

FIGS. 9-14 show another example collapsible water pipe 100. FIG. 9 shows views 900, 910, 915, 920, 925, and 930 of the collapsible water pipe 100. View 900 is a perspective view of the collapsible water pipe 100. View 910 is a back side view of the collapsible water pipe 100. View 915 is taken along lines B-B in view 910 of the collapsible water pipe 100. View 920 is a right side view of the collapsible water pipe 100. View 925 is taken along lines C-C in view 920 of the collapsible water pipe 100. View 930 is a bottom view of the collapsible water pipe 100.

It is noted that 100-series reference numbers are used for the collapsible water pipe 100 to refer to similar components already described above for the collapsible water pipe 10. Therefore, the description of these components may not be fully repeated again here.

An example collapsible water pipe 100 includes a base 112 forming a water basin with a perforated floor. A mouthpiece 118 is connectable to the base 112. A body 114 is connectable to the base 112 The body 114 may have an open bottom and an open top. A neck or extension 116 can be connected to and disconnected from the body 114, thus enabling the collapsible water pipe 100 to be assembled and disassembled (e.g., collapsed). The extension 115 may have an open bottom and an open top.

A percolation plate 113 is provided on the base 112. The percolation plate 113 may be secured to the base 112 (e.g., by threaded or snap-fit connection). The percolation plate 113 is provided within the housing of the body 114. In an example, the percolation plate 113 is secured to the body 114 (e.g., by threaded or snap-fit connection). The percolation plate may be fritted or porous to increase operating efficiency. In an example, the percolation plate 113 is conically shaped. In an example, the conical shape may resemble the shape of a mountain (e.g., including multiple peaks and edges) to increase operating efficiency.

In an example, the collapsible water pipe 100 may be unassembled or collapsed as follows. The extension 116 is removed from the body 114 and the stem or mouthpiece 118 is removed from the base 112. The body 114 is removed from the base 112 so that the extension 116 and the stem can be placed inside the body 114 before reconnecting the body 114 to the base for storage and/or transport. In an example, the water pipe is collapsible to approximately the size and shape of a soda can (e.g., a small cylinder) and thus is disguisable as a soda can or other container.

In an example, the collapsible water pipe 100 may be assembled from a collapsed configuration as follows. The extension 116 and the stem 118 are removed from the body 114. The extension 116 is connected to the body 114, and the stem 118 is connected to the base 112 for assembly in an operating configuration.

In an example, the collapsible water pipe 100 includes an opening 124 in the base 112 to connect the stem 118. The opening 124 in the base 112 may include a lock to secure the stem 118 to the base 112.

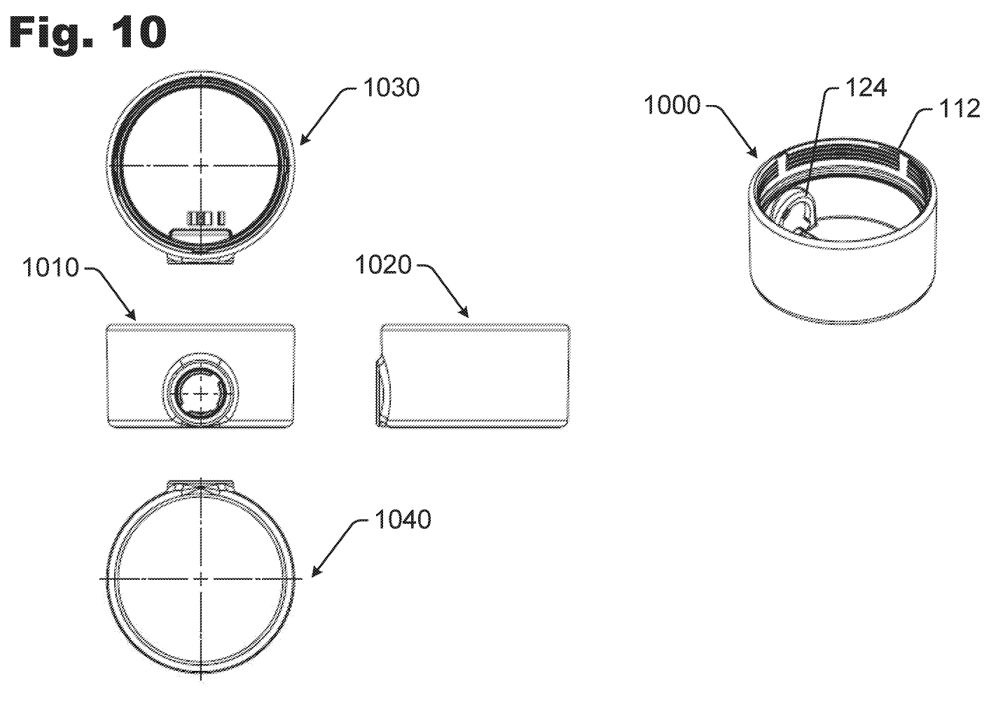

FIG. 10 shows the base 112 of the example collapsible water pipe 100 of FIG. 9. View 1000 is a perspective view of the base 112. View 1010 is a front side view of the base 112. View 1020 is a right side view of the base 112. View 1030 is a top view of the base 112. View 1040 is a bottom view of the base 112.

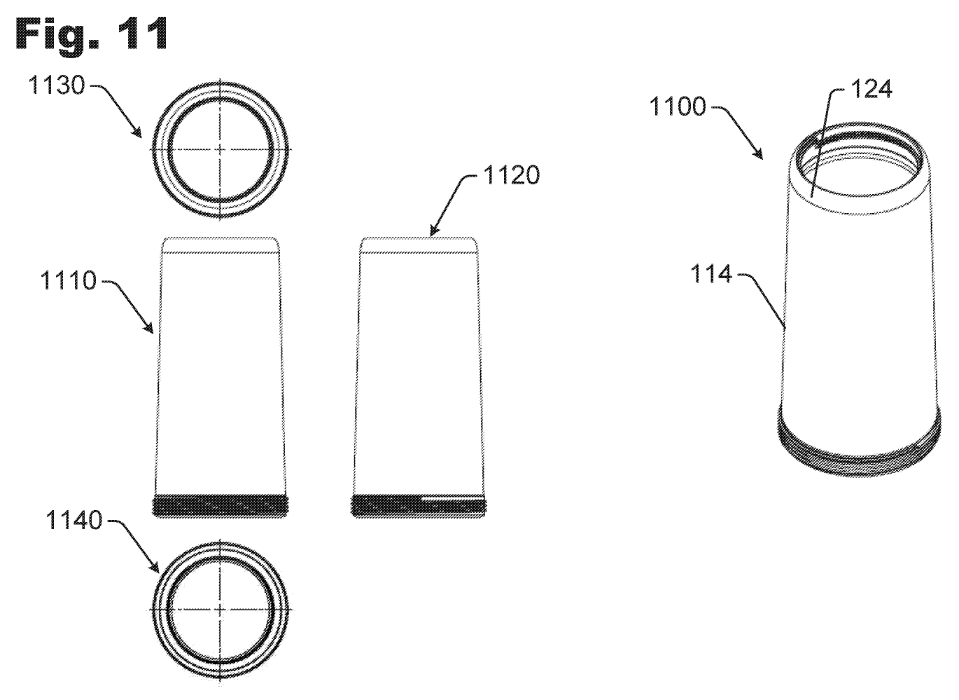

FIG. 11 shows the body 114 of the example collapsible water pipe 100 of FIG. 9. View 1100 is a perspective view of the body 114. View 1110 is a front side view of the body 114. View 1120 is a right side view of the body 114. View 1130 is a top view of the base 112. View 1140 is a bottom view of the body 114.

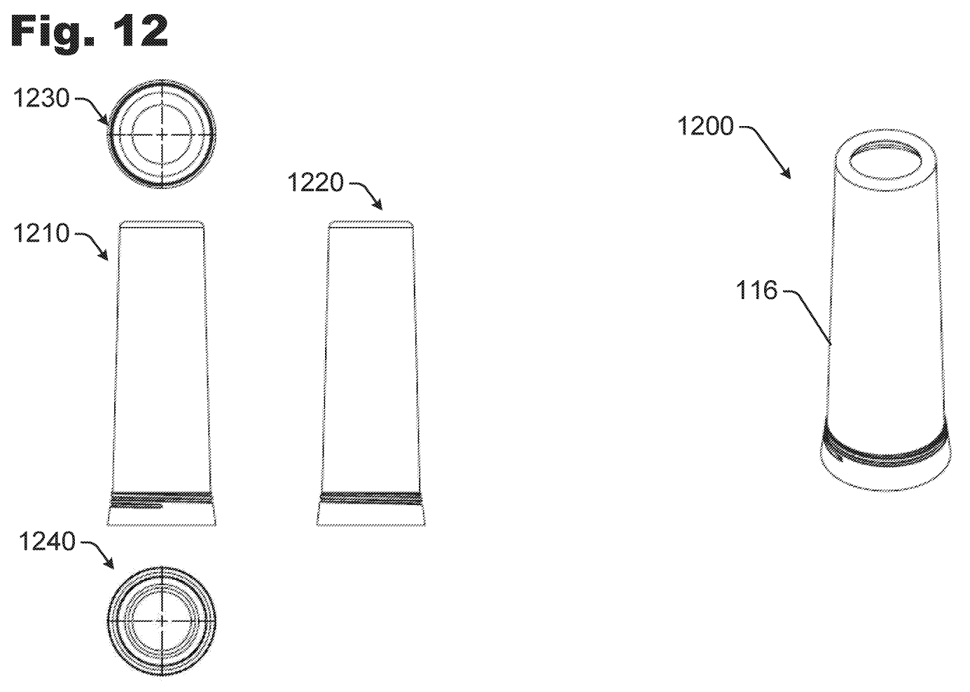

FIG. 12 shows the neck or extension 116 of the example collapsible water pipe of FIG. 9. View 1200 is a perspective view of the extension 116. View 1210 is a front side view of the extension 116. View 1220 is a right side view of the extension 116. View 1230 is a top view of the extension 116. View 1240 is a bottom view of the extension 116.

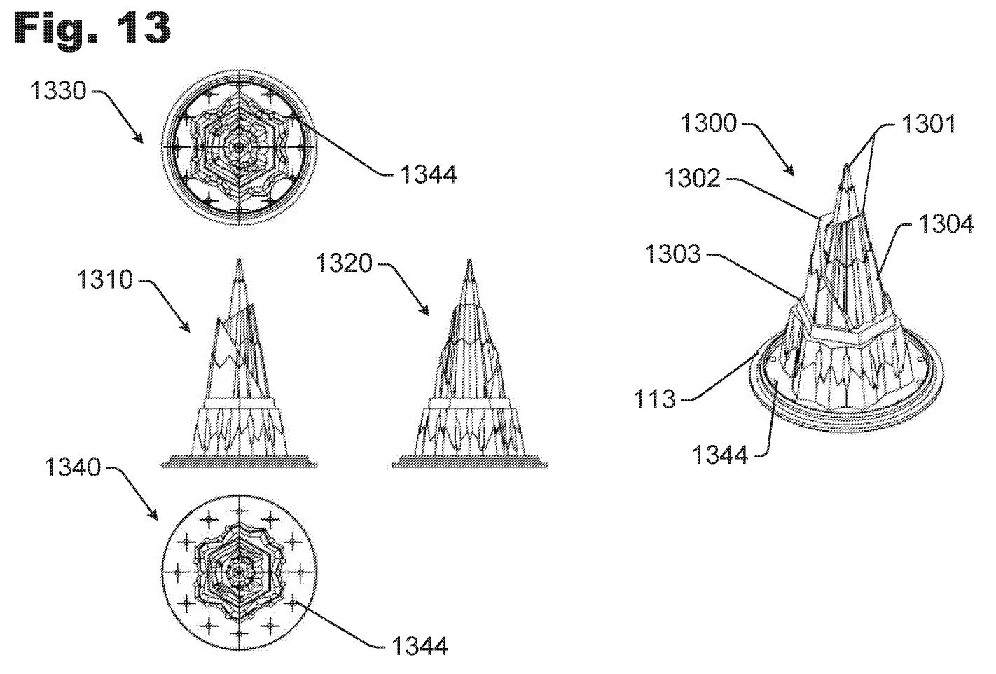

FIG. 13 shows the percolation plate 113 of the example collapsible water pipe of FIG. 9. In this example, the percolation plate 113 is shaped in the form of a conical “mountain” (e.g., having multiple peaks 1301, edges 1302, slopes 1304 and ledges 1303). The formation is specially configured as such to increase efficiency. View 1300 is a perspective view of the percolation plate 113. View 1310 is a front side view of the percolation plate 113. View 1320 is a right side view of the percolation plate 113. View 1330 is a top view of the percolation plate 113. View 1340 is a bottom view of the percolation plate 113. In the example shown in view 1340, the percolation plate 113 is hollow and multiple porous openings 1344 are shown around the perimeter of the base of the “mountain”. Openings may be provided at various locations on the “mountain” sides in addition to or instead of the openings 1344.

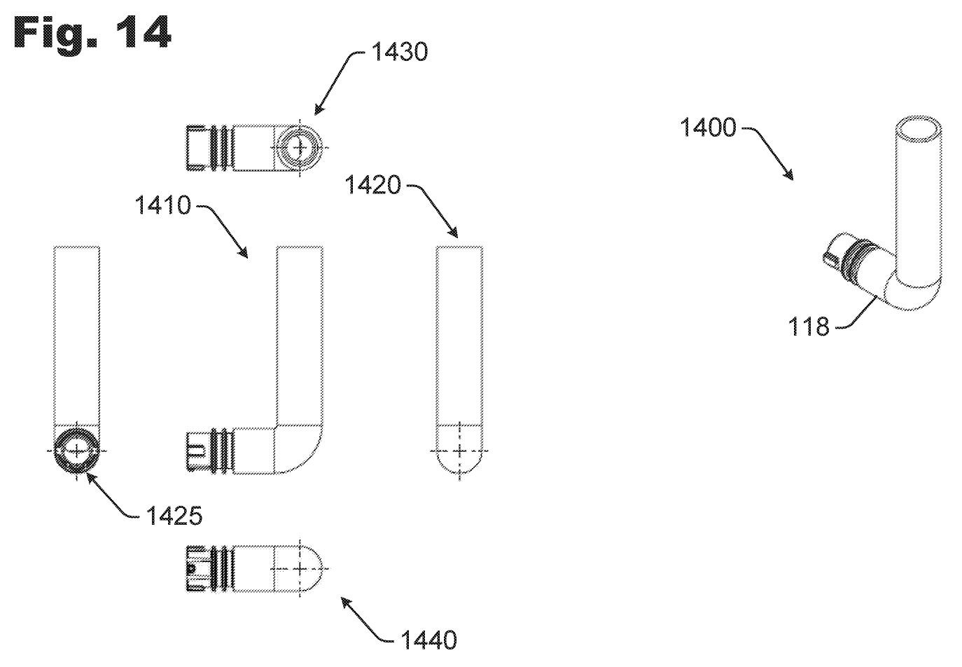

FIG. 14 shows the mouthpiece or stem 118 of the example collapsible water pipe of FIG. 9. View 1400 is a perspective view of the stem 118. View 1410 is a left side view of the stem 118. View 1420 is a back side view of the stem 118. View 1425 is a front side view of the stem 118. View 1430 is a top view of the stem 118. View 1440 is a bottom view of the stem 118.

It is noted that the examples shown and described are provided for purposes of illustration and are not intended to be limiting. Still other examples are also contemplated.

1. A collapsible water pipe, comprising:
a base forming a water basin with a perforated floor;
a mouthpiece connectable to the base;
a percolation plate on the base;
a body connectable to the base over the percolation plate, the body having an open top; and
a neck having an open bottom and an open top, the neck connectable to the open-top of the body.

2. The collapsible water pipe of claim 1, wherein the neck is removed from the body and the stem is removed from the base, and the body is removed from the base so that the neck and the stem are placed inside the body before reconnecting the body to the base for storage and/or transport

3. The collapsible water pipe of claim 1, wherein the neck and the stem are removed from the body, the neck is connected to the body, and the stem is connected to the base for assembly in an operating configuration.

4. The collapsible water pipe of claim 1, further comprising an opening in the base to connect the stem.

5. The collapsible water pipe of claim 4, wherein the opening in the base includes a lock to secure the stem to the base.

6. The collapsible water pipe of claim 4, further comprising a plug for the opening in the base.

7. The collapsible water pipe of claim 1, wherein the neck is connectable to the body by threading into the body.

8. The collapsible water pipe of claim 1, wherein the body has thumb formations.

9. The collapsible water pipe of claim 1, wherein the percolation plate is fritted to increase operating efficiency.

10. The collapsible water pipe of claim 1, wherein the percolation plate has a mountain shaped component to increase operating efficiency.

11. The collapsible water pipe of claim 1, wherein the water pipe is collapsible to approximately the size and shape of a soda can.

12. The collapsible water pipe of claim 1, wherein the water pipe is disguisable as a soda can or other container.

13. A collapsible water pipe, comprising:
a base forming a water basin;
a porous percolation plate on the base;
a body connectable to the base over the percolation plate;
a neck threaded into a top of the body;
a stem interlocking in an opening formed in a side of the base; and
wherein the water pipe is configurable between both an operating configuration and a transport and/or storage configuration.

14. The collapsible water pipe of claim 13, wherein the neck is removed from the body and the stem is removed from the base, and the body is removed from the base so that the neck and the stem are placed inside the body before reconnecting the body to the base.

15. The collapsible water pipe of claim 13, further comprising a mountain shaped component for the percoluation plate, the mountain shaped component shaped to increase operating efficiency.

16. The collapsible water pipe of claim 15, wherein the water pipe is disguisable in a collapsed state to appear as a can or container.

17. A collapsible water pipe, comprising:
a body;
a base forming a water basin, the base connected to the body;
a percolation plate on the base inside the body;
an neck removably connected to a top of the body; and
a stem removably connected to a side of the base;
wherein the neck is removed from the body and the stem is removed from the base, and the body is removed from the base so that the neck and the stem are placed inside the body before reconnecting the body to the base in a transport and/or storage configuration; and
wherein the neck and the stem are removed from the body, the neck is connected to the body, and the stem is connected to the base for assembly in an operating configuration.

18. The collapsible water pipe of claim 17, further comprising a plug for an opening for the stem in the base.

19. The collapsible water pipe of claim 17, wherein the percolation plate is fritted to increase operating efficiency.

20. The collapsible water pipe of claim 19, further comprising a mountain-shaped percolator shaped to increase operating efficiency.
